(19) United States
(12) Patent Application Publication
(10) Pub. No.: US 2026/0350407 A1
(43) Pub. Date: Nov. 5, 2026

(54) SYSTEM AND METHOD OF GENERATING AN ENTANGLEMENT WITNESS FOR DETECTING ENTANGLEMENT IN A QUANTUM SYSTEM

(71) Applicant: THE GOVERNING COUNCIL OF THE UNIVERSITY OF TORONTO, Toronto (CA)

(72) Inventors: Aiden Roel ROSEBUSH, Toronto (CA); Li QIAN, Toronto (CA); Alexander Charles GREENWOOD, Toronto (CA)

(21) Appl. No.: 19/644,503

(22) Filed: Apr. 10, 2026

Related U.S. Application Data
(60) Provisional application No. 63/790,389, filed on Apr. 17, 2025.

(51) Int. Cl. G06N 3/094; G06N 10/20

(52) U.S. Cl. CPC G06N 3/094; G06N 10/20

(57) ABSTRACT

There is provided a system and method for generating an entanglement witness for detecting entanglement in a quantum system. The method including: receiving a target entangled state; training a machine learning model to generate the entanglement witness based on at least two measurement settings until a stopping criterion is reached, training data for the machine learning model is generated by determining eigenstates of Pauli matrices, lambda operators, or Mutually Unbiased Bases of the quantum system or by repeatedly generating and optimizing the training data over separable states using adversarial techniques; optimizing the entanglement witness based on a determination of a most misclassified separable state; and outputting the entanglement witness.

### TECHNICAL FIELD

The following relates, generally, to quantum computing systems; and more particularly, to a method of generating an entanglement witness for detecting entanglement in a quantum system.

### BACKGROUND

Quantum entanglement is a defining feature of physical systems used for quantum technologies. It is exploited in various communication, imaging, and information processing technologies. These technologies become more powerful with higher dimensional quantum systems, such as groups of many quantum 2-level systems (qubits) or systems of many levels (qudits). While quantum hardware capabilities are beginning to allow for quantum states in larger systems to be manipulated, efficiently characterizing states in high-dimensional quantum systems is needed; for example, through the use of entanglement detection.

### SUMMARY

In an aspect, there is provided a computer-implemented method for generating an entanglement witness for detecting entanglement in a quantum system, the method comprising: receiving a target entangled state; generating an entanglement witness for the target entangled state by training a machine learning model to generate the entanglement witness based on at least two measurement settings until a stopping criterion is reached; optimizing the entanglement witness based on a determination of a most misclassified separable state; and outputting the entanglement witness.

In a particular case of the method, the method further comprising receiving a quantity of the measurement settings from a user.

In another case of the method, the machine learning model comprises an adversarial trained model, training of the adversarial trained model comprises repeatedly, until the stopping criterion is reached, alternating between: training of the machine learning model to generate a trial entanglement witness; and generating training data to attempt to invalidate the trial witness.

In yet another case of the method, the machine learning model is trained using training data determined by eigenstates of generalized Pauli matrices, generalized lambda operators, or a set of Mutually Unbiased Basis (MUB) states of the quantum system.

In yet another case of the method, training the machine learning model comprises training a Hermitian matrix for each qubit or qudit in the quantum system and each of the measurement settings, the Hermitian matrices represent quantum observables.

In yet another case of the method, training the machine learning model comprises a linear combination of the Hermitian matrices according to a one-dimensional array of trainable coefficients.

In yet another case of the method, each Hermitian matrix is determined by taking products of the measurement tensors for local measurements across all qubits or qudits for each of the measurement settings.

In yet another case of the method, the one-dimensional array of coefficients includes a bias term that corresponds to an identity operator on the quantum system.

In yet another case of the method, each iteration of training of the machine learning model is evaluated against a loss function, the loss function determined using an expectation value of the entanglement witness at each iteration using the training data.

In yet another case of the method, the machine learning model comprises a support vector machine, and wherein training of the support vector machine comprises: determining Hermitian measurement matrices from the generated training data; determining the entanglement witness from the Hermitian measurement matrices and trainable coefficients; determining an expectation value of training states with the entanglement witness; determining a loss as a maximum hinge loss across all training states; and updating the entanglement witness according to gradients with respect to the loss using differentiation.

In yet another case of the method, at the end of all repetitions, the entanglement witness is optimized to ensure all separable states have a positive expectation value.

In yet another case of the method, optimizing the entanglement witness comprises: determining pairs of trainable matrices with nonnegative real diagonal elements; determining swaps of qubits or qudits for bipartitions of the quantum system; and for each step in a plurality of steps: determining a separable state from the pairs of the trainable matrices across all of the permutations of all of the bipartitions; determining an expectation value of said separable state; performing automatic differentiation to update variables in each of the trainable matrices so as to optimize said separable state by gradient descent; and finding the separable state with the lowest expectation value for the given witness.

In another aspect of the present invention, there is provided a system for generating an entanglement witness for detecting entanglement in a quantum system, the system comprising one or more processing units and a non-transitory memory for data storage, the non-transitory memory in communication with the one or more processing units for execution of: an input module to receive a target entangled state; a machine learning module to generate an entanglement witness for the target entangled state by training a machine learning model to generate the entanglement witness based on at least two measurement settings until a stopping criterion is reached; and an output module to output the entanglement witness.

In a particular case of the system, the input module receives a quantity of the measurement settings from a user.

In another case of the system, the machine learning model comprises an adversarial trained model, training of the adversarial trained model comprises repeatedly, until the stopping criterion is reached, alternating between: training of the machine learning model to generate a trial entanglement witness; and generating training data to attempt to invalidate the trial witness.

In yet another case of the system, the machine learning model is trained using training data determined by eigenstates of generalized Pauli matrices, generalized lambda operators, or a set of Mutually Unbiased Basis (MUB) states of the quantum system.

In yet another case of the system, training the machine learning model comprises training a Hermitian matrix for each qubit or qudit in the quantum system and each of the measurement settings, the Hermitian matrices represent quantum observables.

In yet another case of the system, training the machine learning model comprises a linear combination of the Hermitian matrices according to a one-dimensional array of trainable coefficients.

In yet another case of the system, each Hermitian matrix is determined by taking products of the measurement tensors for local measurements across all qubits or qudits for each of the measurement settings.

In yet another case of the system, the one-dimensional array of coefficients includes a bias term that corresponds to an identity operator on the quantum system.

In yet another case of the system, each iteration of training of the machine learning model is evaluated against a loss function, the loss function determined using an expectation value of the entanglement witness at each iteration using the training data.

In yet another case of the system, the machine learning model comprises a support vector machine, and wherein training of the support vector machine comprises: determining Hermitian measurement matrices from the generated training data; determining the entanglement witness from the Hermitian measurement matrices and trainable coefficients; determining an expectation value of training states with the entanglement witness; determining a loss as a maximum hinge loss across all training states; and updating the entanglement witness according to gradients with respect to the loss using differentiation.

In yet another case of the system, at the end of all repetitions, the entanglement witness is optimized to ensure all separable states have a positive expectation value.

In yet another case of the system, optimizing the entanglement witness by the optimization module comprises: determining pairs of trainable matrices with nonnegative real diagonal elements; determining swaps of qubits or qudits for bipartitions of the quantum system; and for each step in a plurality of steps: determine a separable state from the pairs of the trainable matrices across all permutations of the bipartitions; determining an expectation value of said separable state; and performing automatic differentiation to update variables in each of the trainable matrices so as to optimize said separable state by gradient descent; and finding the separable state with the lowest expectation value for the given witness.

These and other aspects are contemplated and described herein. It will be appreciated that the foregoing summary sets out representative aspects of the invention to assist skilled readers in understanding the following detailed description.

### DESCRIPTION OF THE DRAWINGS

A greater understanding of the embodiments will be had with reference to the Figures, in which:

FIG. 1 is a diagram of an embodiment of system of generating an entanglement witness for detecting entanglement in a quantum system, according to the present invention;

FIG. 2 is a flowchart of embodiments of a method of generating an entanglement witness for detecting entanglement in a quantum system, according to the present invention;

FIG. 3 is a chart showing number of separable training states of adversarial qubit witnesses;

FIG. 4 is a chart showing a loss curve for adversarial training of a 6 qubit W state witness;

FIG. 5 is a chart showing noise tolerances of analytic and generated qubit witnesses;

FIG. 6 is a histogram of expectation values of test data for a 3 qubit W state witness with 2 measurement settings generated with adversarial training;

FIG. 7 is a diagram showing an experimental setup for physical verification experiments;

FIG. 8 is a histogram showing coincidence events added together for all witness measurements for example experiments;

FIG. 9 is a chart illustrating expectation value of the witness compared to p value for example experiments;

FIG. 10 is a diagram showing a quantum circuit used to generate hypergraph states and measure the hypergraph state witness in example experiments; and

FIG. 11 is a graph showing expectation values of a fidelity witness and a witness of the system of FIG. 1, with increasing amounts of noise on quantum computing hardware.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

Any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Entanglement detection can be done by characterizing a quantum system through quantum state tomography (QST). QST involves measuring the expectation values of a complete set of observables, such as Positive Operator-Valued Measures (POVMs), or the Pauli operators in the case of qubit systems. Such approach generally uses far too many measurements to be practical as the size of the quantum system grows. For a quantum system with N particles in a d-dimensional Hilbert space, characterizing the system through QST uses O(d^{2N}) measurements. As a result, QST is not generally practical for large quantum systems.

QST can be made more efficient through approaches like maximum-likelihood estimation, Bayesian methods, or various machine learning techniques. However, these approaches generally still require a tomographically complete set of measurements, which amounts to O(d^{2N}) measurements.

In some cases, completely characterizing the quantum system may not be necessary. Useful information, such as whether the overall state is entangled or separable, can often be extracted from a small number of measurements. Neural networks and convex hull approximations can provide a means of detecting entanglement with fewer measurements than QST. The number of measurements varies relative to the size and details of the quantum system. For example, a neural network approach can use O(3^{N}) measurements for N-qubit quantum systems, where the type of entanglement is already partially known. Such approach only showed a significant reduction in the number of measurements when the states were known to be GHZ-type. Likewise, the convex hull approach, tested in the two-qubit case, used more than 10³ binary classifications, which does not offer a substantial improvement over QST.

A particular entanglement detection approach is to construct what is called an entanglement witness. A witness, [symbol] , is an operator with an expectation value, [symbol] which is non-negative for all separable states and negative only for entangled states that are in proximity to the specific entangled states. Entanglement witnesses are particularly useful for benchmarking quantum systems. Verifying that the desired entanglement is present in a source or as part of a quantum algorithm is crucial to ensuring the success of many quantum protocols. Entanglement witnesses based on local measurements only use O(d^{N}) measurements, which offers superior scaling when compared with other entanglement detection approaches, such as those mentioned above.

Entanglement witnesses are able to provide scaling of measurements due to the fact that each quantum system of dimension d will have no more than d+1 mutually-unbiased bases, where each basis comprises the eigenstates of a generalized Pauli matrix for the quantum system. With d+1 bases, each witness can have no more than (d+1)^{N} orthogonal local measurement operators. In practice, entanglement witnesses use far fewer measurement settings, depending on the target state they are set to detect.

Entanglement witnesses can be compared in terms of the number of measurement settings used and their noise tolerance. In the present context, noise tolerance can be considered as the maximum amount of white noise the entanglement witness can tolerate in a Werner state that is related to the target state ρₑ through the equation that follows, while correctly classifying the state as entangled. In general, a better entanglement witness should have a higher noise tolerance with fewer measurements, but often a trade-off exists between the two metrics. The noise tolerance can be quantified by the largest value of p∈[0,1] for which the entanglement witness has a negative expectation value when detecting the state given by:

$$ρ = ( 1 - p ) {ρ}_{e} + p \frac{𝕀}{{2}^{N}}$$

Measurement settings generally refer to the distinct configurations of measurement bases applied to the quantum system to extract information about a particular state of entanglement; and, in particular, are used by the entanglement witness to verify the presence of entanglement in the quantum system. In the present context, a measurement setting can be considered as a set of measurement operators applied to all qubits in a given quantum system. To evaluate a state using an entanglement witness, the expectation value for each measurement setting is found using copies of the state under test. In this arrangement, advantageously, measurement settings are not necessarily defined by counting the total number of measurements done on all qubits in order to reflect how many copies of a given state are necessary to evaluate it.

Entanglement witnesses can be determined using various approaches, such as using stabilizer formalism and fidelity approaches. However, the number of measurements to generate the entanglement witness in such approaches can still be significant and substantial, depending on the specific context. Further, such approaches have generally rarely been shown to produce entanglement witnesses with optimal noise tolerances, and in some cases, have not been shown to use the fewest possible measurements. Additionally, while the stabilizer formalism and fidelity approaches can be applied to many classes of states, it is not straightforward to do so. Often, substantial instructions, such as through the publishing of dedicated papers, are required to instruct how such approaches should be used; requiring dedicated research for detection of particular classes of states like hypergraph states and cluster states.

Using an analytical means of constructing an entanglement witness also forces experimentalists to choose between specific numbers of measurement settings, which may not be optimal relative to their available resources, and the accuracy by which they may be able to determine measurement expectation values. For instance, to construct an entanglement witness for an N qubit hypergraph state with a single maximum cardinality hyperedge, the stabilizer approach can construct an entanglement witness with N measurements, while the fidelity approach can produce an entanglement witness with

$$\frac{{3}^{N} - 1}{2}$$

measurements. However, the fidelity approach produces entanglement witness with much higher noise tolerance. Depending on the hardware used to produce the states being detected, using many measurements to detect entanglement might or might not be advantageous. Determination of an entanglement witness with some number of measurements in the wide range between these two values offers a more optimal trade-off between the expense of measurement and the robustness to noise.

Further, the stabilizer and fidelity approaches alone are not enough to produce entanglement witnesses analytically for the detection of arbitrary entangled states, such as mixed states or general qudit states. Construction of entanglement witnesses knowing only the density matrix of a target state also poses problems. Using the stabilizer formalism for mixed states, entanglement witnesses can only be constructed if a decomposition into a convex combination of pure states exists, such that those pure states share a set of stabilizing operators. If no such decomposition exists, an entanglement witness determined by the fidelity approach is used, which in general tends to use more measurement settings for larger quantum systems. Accordingly, analytical approaches of deriving entanglement witnesses are non-optimal and inaccessible, and thus, are very inconvenient for experimentalists.

Machine learning can be used to automate the generation of entanglement witnesses in order to address these issues. Support vector machines (SVMs) are a machine learning technique commonly used for binary classification of labeled data. SVM approaches for the generation of entanglement witnesses have yielded entanglement witnesses with larger noise tolerances than some existing entanglement witnesses but offer no guarantees on the maximum number of measurement settings, as a user cannot specify how many settings will ultimately be used. These approaches offer a convenient means of generating entanglement witnesses for specific quantum systems, but suffer from the drawback that the user cannot specify how many measurement settings they wish to use for an entanglement witness. As a result, they may not compete favourably with analytical approaches in terms of providing fewer measurements or higher noise tolerances. Furthermore, these approaches require bespoke software to be programmed for each quantum system that an entanglement witness might exist in, adding to the difficulty of applying them to arbitrary cases. Additionally, these approaches produce numerical, approximate entanglement witnesses, which do not necessarily guarantee each entanglement witness found will correctly classify all separable states.

The present embodiments advantageously provide a framework for constructing entanglement witnesses using machine learning models. In various approaches of the present embodiments, general measurement settings are constructed and trained directly, along with coefficients and a bias term. In this way, a user can specify any suitable number of measurement settings (greater than two) with which the user wishes to construct an entanglement witness. A machine learning model is then generated according to the quantum system to which a target state belongs, and a differential programming framework provides accuracy. Advantageously, the present embodiments can be used for any quantum system of qubits or qudits (subject to available computing resources).

Example experiments conducted by the present inventors, described herein, show that the present embodiments provide better results than analytical approaches without requiring an understanding of the target state of entanglement to be detected. In this manner, the present embodiments make entanglement detection an automated process, where any entangled state can be dealt with indiscriminately.

The present embodiments also advantageously overcome another drawback of other machine learning approaches, namely, the size of training data for training the model. Generally, the least or minimum amount of training data for training an entanglement witness of an N qubit quantum system is 6^{N} separable states, creating memory issues for larger quantum systems. In the present embodiments, training of the model includes the benefits of universality, choice of the number of measurements, and accuracy, and advantageously, the size of training data is independent of the size of the quantum system. The present embodiments also produce entanglement witnesses with even fewer measurements and with higher noise tolerances than other machine learning approaches.

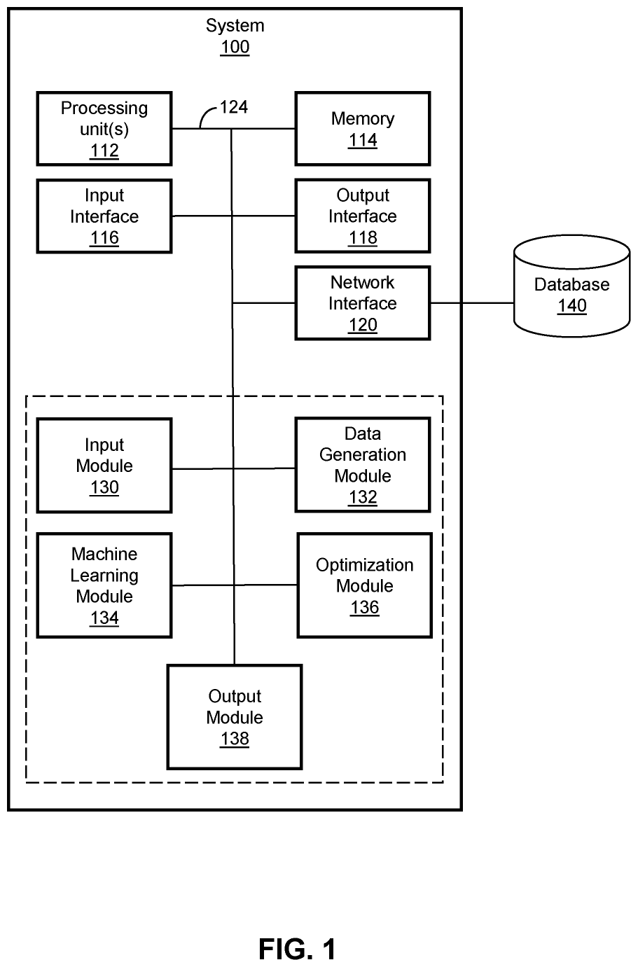

FIG. 1 shows a system 100 for generating an entanglement witness for detecting entanglement in a quantum system. The system 100 can be communicatively linked to a database 140. In an embodiment, the system 100 has a number of physical and logical components, including one or more processing units 112 (each comprising one or more processors), non-transitory memory 114, an input interface 116, an output interface 118, a network interface 120, and a local bus 124 enabling the one or more processing units 112 to communicate with the other components. The one or more processing units 112 execute various modules, as described below in greater detail, in addition to other operating systems and/or software. The memory 114 provides relatively responsive storage to the one or more processing units 112. The input interface 116 enables an operator to provide input via an input device, such as a keyboard, mouse, touchscreen, or the like. The output interface 118 outputs information to output devices, such as a display, screen, speakers, or the like. In some cases, the input interface 116 and the output interface 118 can be the same device (e.g., a touchscreen or tablet computer). The network interface 120 permits communication with other computing or storage devices, such as the database 140, which can be locally or remotely located from the system 100. The network interface 120 may also permit communication with various kinds of remote storage, such as cloud-based storage.

In various embodiments, the one or more processing units 112 can be configured to execute a number of conceptual and/or functional modules, for example, an input module 130, a data generation module 132, a machine learning module 134, an optimization module 136, and an output module 138. In further cases, functions of the above modules can be combined or executed on other modules. In some cases, functions of the above modules can be executed on remote computing devices, such as centralized servers and cloud computing resources communicating over the network interface 120.

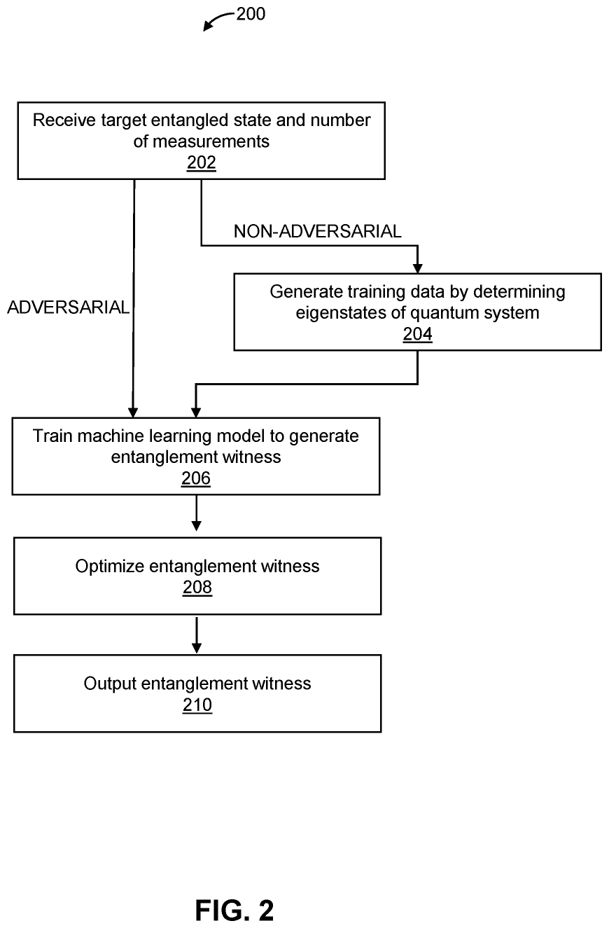

FIG. 2 illustrates a computer-implemented method 200 for generating an entanglement witness for detecting entanglement in a quantum system.

At block 202, the input module 130 receives a target entangled state and, in most cases, a number of measurement settings. The target entangled state and number of measurement settings can be received from the input interface 116, the network interface 120, and/or the database 140, as appropriate.

At block 204, in some cases where non-adversarial techniques are used, the data generation module 132 generates training data by determining the eigenstates of Generalized Pauli matrices, lambda operators, or Mutually Unbiased Bases of the quantum system. In cases where adversarial techniques are used, training data is generated during training of the machine learning model by repeatedly generating and optimizing the training data over separable states using the adversarial techniques.

At block 206, the machine learning module 134 trains a machine learning model to generate the entanglement witness based on at least two measurement settings. Training can occur until a stopping criterion is reached.

In cases where training is performed using non-adversarial techniques, such that the training data is generated by determining the eigenstates of Generalized Pauli matrices, lambda operators, or Mutually Unbiased Bases of the quantum system, the data generation module 132 generates the training data, as indicated at block 204. In one such example, generating training data comprises generating separable training data, for which generalized Pauli operators may be used, and generating entangled training data, for which a single copy of the target entangled state may be used. Furthermore, when non-adversarial training techniques are used, the stopping criterion may be a specified number of epochs over which training is to be performed. This number of epochs can be preset or received via the input module 130. As described herein, the training of the model, at block 206, will use the target entangled state and the generated training data, but the training process will depend on the type of model and training approach.

The machine learning model may be trained until variance in the loss over a set number of iterations drops below a prescribed threshold, such as one that is empirically selected. Such stopping criterion ensures training converges and can be adjusted based on the desired runtime or quality of the witnesses to be generated. Furthermore, the machine learning model may be trained according to a user-specified learning rate.

When the machine learning model is trained using adversarial techniques, training, as part of block 206, comprises repeatedly, until a stopping criterion is reached, alternating between two interdependent stages: (1) training of the machine learning model to generate a trial witness for the entanglement witness, and (2) generating training data to attempt to invalidate the generated trial witness. In such a training approach, the latest witness and the optimized states may be stored at the end of each repetition, and at the end of all repetitions, the entanglement witness can be corrected to ensure all separable states have a negative expectation value.

At block 208, the optimization module 136 optimizes the entanglement witness based on a determination of a most misclassified separable state, as described herein.

At block 210, the output module 138 outputs the optimized entanglement witness to the output interface 118, the network interface 120, and/or the database 140, as appropriate, to be used for determining entanglement of states in a quantum system.

The following provides an exemplary pseudocode approach demonstrating a particular case of the method 200 for generating the entanglement witness:
Problem Input: N, d, M ∈ [symbol]
Output: Entanglement witness W₁.
Establish: N≥2, d≥2, M≥2
   Generate separable training data. In one example, the eigenstates of generalized Pauli operators are used.
   Train prototype entanglement witness [symbol]
   Optimize to find the most misclassified separable state ρₛ for the prototype witness.
   Use ρₛ to produce a corrected entanglement witness [symbol] as [symbol] ← [symbol] −Tr(ρₛ [symbol] ) [symbol] , where [symbol] is the identity operator of the quantum system.

To generate training data for the separable states, the data generation module 132 uses pure fully separable eigenstates of the Pauli matrices for quantum systems of qubits, or analogously, the pure fully separable eigenstates of the lambda operators, or the basis states for the set of Mutually Unbiased Bases (MUBs). Using these eigenstates minimizes the amount and quantity of the training data. Furthermore, the system 100 provides an adversarial training approach, as described herein, in which the training data is advantageously generated as the model is trained.

In particular cases, the machine learning model, implemented by the machine learning module 134, can include a differential program with a single linear layer at its end, or a high dimensional SVM. In general, quantum observables for discrete quantum systems take the form of Hermitian matrices. A Hermitian matrix is created and trained for each qudit and each measurement setting as part of the machine learning model. Hermitian matrices can be directly trained and allowed to take any general form, instead of parameterizing in terms of specific bases of measurements. These Hermitian matrices can be represented in a single tensor, such as H∈ [symbol] .

With each measurement setting, the value of exactly 2^{N}−2 additional measurements on subsets of the qudits in the quantum system can be inferred. For example, if the machine learning model provides one measurement setting for three qubits as X⊗Y⊗Z, where X, Y and Z represent the Pauli matrices, the expectation value can be computed for X⊗Y⊗I, X⊗I⊗Z, I⊗Y⊗Z, X⊗I⊗I, I⊗Y⊗I, I⊗I⊗Z without additional measurements. Here I represents the identity operator on each qudit, indicating that no measurement is taken. These additional measurements can be stored in a tensor J of dimension M(2^{N}−2)×N×d×d.

An entanglement witness can be considered as a linear combination of observables; thus, a one-dimensional array of coefficients c can be trained for each observable. A bias term, which corresponds to the identity operator on the quantum system, can be included. Overall, c has 1+M×(2^{N}−1) elements.

The entanglement witness before regularization and without the identity term is denoted as [symbol] . To compute the entanglement witness before regularization, [symbol] is set as:

$${W}_{r} = {\sum }_{i = 1}^{M} {c}_{i} {⊗}_{j} {H}_{ij} + {\sum }_{i = M + 1}^{1 + M \times ( {2}^{N} - 1 )} {c}_{i} {⊗}_{j} {Y}_{( i - M ) , j}$$

which is a linear combination of each derived measurement setting with the corresponding coefficient.

With each iteration, a new entanglement witness is constructed and evaluated with a unique loss function. The loss function, in some cases, can be similar to a hinge loss that is typically used for SVMs. The expectation value of the entanglement witness can be determined at each training step with all of the training data. These predictions are labelled as yₚᵢ for each training state ρᵢ. Since [symbol] is normalized, it is known that −1≤yₚᵢ≤1. The ground truth label yₜᵢ of each separable state is set to be +1, and the ground truth label of the sole entangled target state is set as −1.

The loss can be computed as:

$$l = {max}_{i} \{ max ( 1 - {y}_{t i} {y}_{p i} , 0 ) \} .$$

In most cases, all training data can be considered at once such that full batch training is performed. The maximum across the full batch can be taken, instead of the average, because the average loss across states for a linear operator reaches a minimum when the loss of the average state is zero. Taking the average loss allows the model to learn only to correctly classify the average of the training states correctly. Additionally, since the measurement operators are initialized randomly, entangled and separable states tend to almost always be classified together, so the entanglement witness will be trained to set the loss of the overall average state to zero. In such cases, most separable states remain misclassified.

As described herein, trainable variables h_{reaL} and h_{imag} are real valued tensors of size M×N×d×d for M measurements and an N qudit quantum system of dimension d. The trainable variables are combined to produce intermediate variables h and H. Additionally, coefficients in array c, which has 1+M×(2^{N}−1) elements, are trained. c and H are combined, together with additional inferred measurements J, to produce, [symbol] , [symbol] , and the determined prototype entanglement witness [symbol] .

As described earlier, a stopping criterion can be used to determine when to cease training. For example, let T be a loss variability threshold, which can be defined as the variance of the loss over some number of training steps, called the patience P. To generate witnesses with higher noise tolerance, a smaller threshold of variance and larger patience is preferably used. The variance is only computed after the first P steps to allow the model time to train. In one example of non-adversarial training, a threshold of 10⁻⁴ and a patience of 2000 are used. These values can be empirically selected to ensure reasonably good witnesses are produced and that the training converges quickly. With a significantly smaller threshold, the training continues for a long time and performance does not substantially improve. Variable i is incremented to encode the number of training steps.

The following provides an exemplary pseudocode approach for non-adversarial training to generate an entanglement witness, in accordance with the method 200. Let l be the value of loss function, as previously described. Also, let lr represent the learning rate, or a small constant value used to adjust each trainable variable based on its gradient with respect to the loss. The complete training data, EntRhos and SepRhos, can be stored in one tensor, rhos, from which pi represents any element. The exemplary pseudocode demonstrating the non-adversarial training approach includes:

### Problem Input:

Entangled target state
Separable training data; pure fully separable eigenstates

### Parameters:

User specified number of measurements M;
User specified number of qubits N;
User specified dimension d;
Number of training steps (‘steps’), for example, 2000;
Loss variance threshold T;
Patience P.
   Output: Prototype Entanglement Witness [symbol] for the Target State Stored in EntRhos
Initialize trainable TensorFlow variables.
While loss variance ≥T or i≤p, or for i≤steps, do
   Assemble Hermitian measurement matrices H from trainable variables.
   Assemble inferred measurements J from measurement matrices.
   Assemble entanglement witness [symbol] from all measurement matrices and trainable coefficients.

$${𝒲}_{r} ← {\sum }_{i = 1}^{M} {c}_{i} {⊗}_{j} {H}_{ij} + {\sum }_{i = M + 1}^{1 + M \times ( {2}^{N} - 1 )} {c}_{i} {⊗}_{j} {Y}_{( i - M ) , j}$$

Add bias term to entanglement witness, create prototype entanglement witness [symbol] .

[symbol]

←c₀ [symbol] + [symbol]
Compute expectation value of all training states with entanglement witness [symbol] .
Compute loss I as the maximum hinge loss across all training states.

l←maxᵢ{max{1−yₜᵢ×Tr(ρᵢ [symbol] ),0}}
If i>P, compute the loss variance over the last P steps.
Update all trainable variables according to gradients with respect to loss l using automatic differentiation.
Increment step counter i.

Since the hinge loss aims to optimize the margin on both sides of the entanglement witness hyperplane, the entanglement witness [symbol] is corrected to ensure optimal accuracy. Additionally, since the machine learning model is trained using a small subset of all separable states, yet perfect accuracy is necessary, loss functions like those used for weighted SVMs or cost sensitive SVMs are not suitable.

To correct [symbol] , the separable mixed state ρₛ with the lowest expectation value is found, which serves as the most misclassified state. Another differential operation, optimizeMixedSep, can be used to find ρₛ, as described herein. optimizeMixedSep modifies the prototype entanglement witness and is a differential program that returns the most misclassified separable state ρₛ of the prototype entanglement witness. The entanglement witness is adjusted accordingly to ensure this state has an expectation value of precisely 0 such that the final entanglement witness [symbol] can be outputted.

To optimize over the space of mixed separable states, all permutations of all bipartitions of the complete quantum system can be considered. Only bipartitions of the quantum system can be considered because further partitioning is still possible when each subsystem is represented completely by arbitrary density matrices. A subsystem which can take on a state represented by any valid density matrix could have any suitable degree of separability. As described herein, a separable state ρ is generally defined as one which can be written as a convex combination of product states, or

$$ρ = {\sum }_{i} {ρ}_{a} ⊗ {ρ}_{b} .$$

Here ρₐ and ρ_{b} represent any mixed states in their respective subsystems, entangled or otherwise, meaning that if they are parameterized completely then smaller subsystems may not be considered.

The present inventors have determined that, advantageously, parameterization can represent all possible separable states. By virtue of guaranteeing that every mixed state in each subsystem can be generated, and any mixture of states for a given bipartition and permutation can be represented, the system 100 can find the most misclassified separable state for an entanglement witness, given by

ρₛ=argmin Tr(ρ [symbol] )

for any prototype entanglement witness [symbol] and all separable states ρ. The optimization [symbol] performed by the system 100 spans the space of separable states in any quantum system. The differential mixed state optimization can accommodate any quantum system of qudits. The variables are algorithmically generated to optimize across the space of separable mixed states based on a user specified dimension d and number of qudits N. This optimization, optimizeMixedSep( [symbol] , d, N), is detailed in greater detail herein.

For each bipartition, additional trainable mixed state subsystems are used to cover the total number of permutations. For this, a convex combination of v(N, n, d) mixed states for each bipartition and permutation can be used, with:

$$v ( N , n , d ) = \frac{{d}^{2 ( N - n )} + {d}^{( N - n )}}{2}$$

where n represents the number of qubits in the smaller of the two subsystems in each case. Additionally, there can be exactly

$$( \begin{matrix}N \\ n\end{matrix} )$$

possible permutations of each bipartition, so [symbol] identical separable states are represented as:

$$𝒩 ( N , n , d ) = ( \begin{matrix}N \\ n\end{matrix} ) \times ( \frac{{d}^{2 ( N - n )} + {d}^{( N - n )}}{2} )$$

In total S product states are represented, with:

$$S ( N , n , d ) = {\sum }_{n = 1}^{⌊ N / 2 ⌋} ( \begin{matrix}N \\ n\end{matrix} ) \times ( \frac{{d}^{2 ( N - n )} + {d}^{( N - n )}}{2} )$$

To count the number of trainable parameters, the number of copies of separable states per the equation provided herein can be multiplied by the number of parameters in each pair of separable states and sum over all bipartitions. For a state of n qudits of dimension d, d²ⁿ real parameters and d²ⁿ imaginary parameters can be created to form lower triangular matrices L which are assembled into mixed states per the equation provided herein. Overall, a single mixed state for a single bipartition includes d²ⁿ⁺¹+d^{2(N-n)+1} trainable variables. An additional array of real valued trainable variables p can be used to represent the coefficients of density matrices in the final convex combination of product states, per the equation provided herein. The total number of trainable variables used for the optimizer can be given by

$$S ( N , n , d ) = {\sum }_{n = 1}^{⌊ N / 2 ⌋} ( \begin{matrix}N \\ n\end{matrix} ) \times ( 2 {d}^{2 n} + 2 {d}^{2 ( N - n )} + 1 ) \times ( \frac{{d}^{2 ( N - n )} + {d}^{( N - n )}}{2} )$$

Memory usage for the optimizer for some small systems is shown in Table 1 below. The overall memory usage is higher due to Tensorflow features, intermediate variables, and the size of the software itself.

TABLE 1
Optimizer Memory Usage for Small Systems

| d | N | Memory Usage | |
|---|---|---|---|
| 2 | 4 | 189.0 | KB |
| 2 | 5 | 3.3 | MB |
| 2 | 6 | 62.5 | MB |
| 2 | 7 | 1.2 | GB |
| 3 | 2 | 3.5 | KB |
| 4 | 2 | 10.4 | KB |
| 5 | 2 | 24.2 | KB |
| 6 | 2 | 48.7 | KB |
| 7 | 2 | 88.3 | KB |
| 3 | 3 | 195.5 | KB |

Generally, the parameterization for representing all separable states depends on representation of arbitrary density matrices in some subsystems, taking their tensor products, and taking convex combinations of different permutations of qubits. Density matrices ρ can be constructed using Cholesky decomposition as:

$$\frac{{LL}^{†}}{t r ( {LL}^{†} )}$$

where L is lower triangular, the values Lᵢᵢ are real and non-negative, and all other elements are complex valued and can vary freely. Notably, every density matrix ρ has at least one Cholesky decomposition defined by L.

If L is set arbitrarily, then all possible states ρ which account for k-separability and entanglement within p can be constructed. This makes it possible to construct a k-separable state with only bipartitions. A state or permutation of ρ₁⊗ρ₂ then accounts for all possible states or permutations of the tensor product between any mixed state in each subsystem, represented as (Σᵢ pₐᵢ⊗ⱼρₐᵢⱼ)⊗(Σᵢ p_{bi}⊗ⱼρ_{bij}). A state like ρ₁⊗ρ₂ does not necessarily account for all states which can be reached by some convex combination of mixed states in each subsystem, which may be written as Σᵢ pᵢ ρᵢ⊗ρ₂ᵢ. Note that in every case, ρ₁ᵢ and ρ₂ᵢ are defined to be freely varying, so they can represent any mixed state for their subsystem. These can be encoded with trainable variables, which can be adjusted to take on any value corresponding to a valid density matrix via the Cholesky decomposition. A state or permutation represented by ρ₁⊗ρ₂ may be explicitly written out as the block matrix:

$$( \begin{matrix}{ρ}_{111} {ρ}_{2} & {ρ}_{112} {ρ}_{2} & … \\ {ρ}_{121} {ρ}_{2} & {ρ}_{122} {ρ}_{2} & … \\ ⋮ & ⋮ & ⋱\end{matrix} )$$

where ρ₁ᵢⱼ is element ij of the matrix ρ₁.

All blocks with the size of ρ₂ of this matrix are always linearly dependent, since they are scalar multiples of ρ₂. Thus, summing many independently varying copies of a matrix of the same permutation and size, the block matrix can be written as:

$$ρ = {\sum }_{i}^{S} {p}_{i} {ρ}_{1 i} ⊗ {ρ}_{2 i} = ( \begin{matrix}{\sum }_{i}^{S} {p}_{i} {ρ}_{1 i 11} {ρ}_{2 i} & {\sum }_{i}^{S} {p}_{i} {ρ}_{1 i 12} {ρ}_{2 i} & … \\ {\sum }_{i}^{S} {p}_{i} {ρ}_{1 i 21} {ρ}_{2 i} & {\sum }_{i}^{S} {p}_{i} {ρ}_{1 i 22} {ρ}_{2 i} & … \\ ⋮ & ⋮ & ⋱\end{matrix} )$$

where each block is an arbitrary linear combination (with complex valued coefficients) of the matrices {ρ₁ᵢ}. Since this matrix is Hermitian,

$${ρ}_{a b} = {ρ}_{b a}^{*}$$

and so ρ_{ab} and ρ_{ba} will always be linearly dependent. However, the lower triangular blocks may be made linearly independent amongst themselves.

In some cases, suppose first that ρ₁ᵢ is a larger matrix than ρ₂ᵢ in the previous equation, representing a quantum system of fewer qubits. If the lower triangular were linearly dependent, then the following would apply:

$${\sum }_{j \geq k} {a}_{j k} {\sum }_{i}^{S} {p}_{i} {ρ}_{1 ijk} {ρ}_{2 i} = 0$$

for some complex coefficients aⱼₖ not all zero, according to the definition of linear independence. By linearity, the order of summation in the previous equation can be changed to write the sum as:

$${\sum }_{i}^{S} {ρ}_{2 i} {\sum }_{j \geq k} {a}_{j k} {p}_{i} {ρ}_{1 ijk} = 0$$

Suppose {bⱼₖ} can be found to be not all zero such that:

$${\sum }_{j \geq k} {b}_{j k} {p}_{i} {ρ}_{1 ijk} = 0$$

for every i. The elements of each matrix ρ₁ᵢ can be arranged into vectors of length S (the value sought), where each vector is denoted by the pair of indices jk. For example, the elements at index 00 of the first matrix in the bipartition can be taken, for every matrix in the convex combination. Since each matrix ρ₁ᵢ is Hermitian, linear independence is only sought among the lower triangular elements with j≥k. Arranging those elements into a vector, there is one vector. The complete set of vectors is defined as:

$${v}_{jk} = ( \begin{matrix}{p}_{1} {ρ}_{11 jk} \\ {p}_{2} {ρ}_{12 jk} \\ ⋮ \\ {p}_{S} {ρ}_{1 S jk}\end{matrix} )$$

If the above equation for {bⱼₖ} is true, then the vectors in the above equation for vⱼₖ are linearly dependent. Then, aⱼₖ=bⱼₖ can be set and the sum can be forced to zero.

As the vectors vⱼₖ are linearly independent, S can be chosen to be at least as large as the number of possible vectors vⱼₖ. In other words, the matrix v with elements ρᵢⱼₖ has linearly independent columns. Since the size of each ρ₁ᵢ is fixed, nu always has the same number of columns, but the number of rows can be varied by increasing S. For ρᵢ₁∈ [symbol] , v will have the number of columns given by the number of lower triangular elements of ρᵢ₁, which is

$$\frac{{n}_{1}^{2} + {n}_{1}}{2} .$$

Since the rank of v is bounded by

$$min \{ \frac{{n}_{1}^{2} + {n}_{1}}{2} , i \} , then S \geq \frac{{n}_{1}^{2} + {n}_{1}}{2} .$$

Suppose that ρᵢ₂∈ [symbol] and ρᵢ₁∈ [symbol] , but now with n₂>n₁. Since the tensor product depends on the constructing a block matrix by multiplying ρ₂ with the elements of ρ₁, and scalar multiplication is commutative, the same elements of p₁⊗ρ₂ exist in ρ₂⊗ρ₁, but in a different arrangement. Hence

$${ρ}_{1} = {\sum }_{i}^{S} {p}_{i} {ρ}_{1 i} ⊗ {ρ}_{2 i}$$

has exactly the same elements as

$${ρ}_{2} = {\sum }_{i}^{S} {p}_{i} {ρ}_{2 i} ⊗ {ρ}_{1 i}$$

in a different arrangement, since each term in the sum obeys the above principle. Then, linear dependence exists between various elements of ρ₂ just as linear dependence exists between the blocks of the matrix ρ₁. These blocks can be relabeled and the same approach as above can be followed to show that

$$S \geq \frac{{n}_{2}^{2} + {n}_{2}}{2} .$$

Hence, to eliminate all possible linear dependence within the resulting k-separable state,

$$S = max \{ \frac{{n}_{1}^{2} + {n}_{1}}{2} , \frac{{n}_{2}^{2} + {n}_{2}}{2} \}$$

for the minimum necessary value of S. Note that each ρᵢⱼ can vary freely through the Cholesky decomposition, so each block or set of elements can already span their respective subspace. The choice of S can guarantee that they can do so independently, and thus, span the entire space of k-separable states.

For training of the machine learning model, each element of the trainable variables can be initialized by sampling from a uniform distribution between −1 and 1. Generally, this initialization distribution can be arbitrary, and it should be understood that the variables can be initialized in other suitable ways.

In a particular case, for each step of the training loop, states are created for the subsystems in each distinct bipartition according to the Cholesky formula:

$$ρ = \frac{{LL}^{†}}{T r ( {LL}^{†} )}$$

for a lower triangular matrix L with real, non-negative diagonal elements.

The above steps are repeated to produce S(N, n, d) pairs of density matrices, which is enough to span the subspace corresponding to every permutation of every bipartition of qubits. Then, tensor products are taken and each swapping operator stored in the array swaps is applied to the corresponding density matrices. Finally, the convex combination of these density matrices, with coefficients p, is taken to produce a final separable state ρₜₑₛₜ; but first each element of p is constrained as:

$$p [ i ] ← \frac{{p [ i ]}^{2}}{{\sum }_{i} {p [ i ]}^{2}}$$

In most cases, these density matrices can assume any rank depending on the value of all free parameters, and can be arbitrarily pure or mixed.

At the end of each optimization step, the loss can be computed as I←Tr(ρₜₑₛₜ [symbol] ), which is the expectation value of the prototype entanglement witness from the measurement training. A step of gradient descent is performed to minimize the loss and find the most misclassified separable state for the entanglement witness [symbol] .

A stopping criterion can be used and can be based on the variance in the loss. In one example, a loss threshold t is 10⁻⁶ and patience p is 2000 steps. The number of steps completed is incremented using counter i. The variance in the loss over the last p steps can be computed, and the optimization can be stopped when the variance drops below t. The small threshold and long patience ensure the loss has stabilized at a minimum, which helps ensure the optimizer has found the most misclassified separable state up to numerical precision. The optimization can also be run for a set number of steps, typically 2000.

The following provides an exemplary pseudocode approach for differential mixed separable optimization to generate an entanglement witness, in accordance with the method 200:

### Problem Input:

Number of qudits N
Dimension of qudits d
Prototype entanglement witness

[symbol]

### Parameters:

Learning rate lr
Patience p
Loss variance threshold t
   Output: Most Misclassified State of [symbol] Given by ρₛ.

### Steps:

Create trainable lower triangular matrices L with nonnegative real diagonal elements. Each matrix L represents quantum systems of up to N/2 qudits
Compute all swaps of qudits for all bipartitions of the quantum system.]
While loss variance ≥t or i≤p
   Assemble separable state ρ using the following equation (reproduced from above) from pairs of matrices L, across all permutations of all bipartitions of the quantum system, computing permutations with the swaps

$$ρ = \frac{L {L}^{†}}{T r ( {LL}^{†} )}$$

Compute expectation value Tr(ρ [symbol] )
Use automatic differentiation to update each variable in each matrix L with learning rate lr
If i≥p compute loss variance over last p steps
Increment step counter i

Adversarial training as provided as part of method 200 can be extended to produce entanglement witnesses with higher noise tolerance. The approach herein resembles Generative Adversarial Training, in which one model generates new training examples meant to be misclassified by the other. In this sense, the two models compete, as the generator finds more extreme edge cases while the classifier learns to classify all examples correctly. In the present embodiments, the generator is the mixed state optimizer, which has been described with respect to differential mixed state optimization; while the classifier is the measurement training described herein with respect to obtaining training measurements. The two training approaches can be merged such that they can be alternated. For example, running one step of the main training loop in the entanglement witness training and running the differential mixed state optimization. The latest entanglement witness can be stored, and all states considered by the optimizer. One copy of the target entangled state can be used as training data. At the end, the separable state optimization can be performed again and the entanglement witness can be corrected to ensure all separable states have negative expectation value. This is because the loss function encourages prototype witnesses with separation between both the entangled and separable training data states.

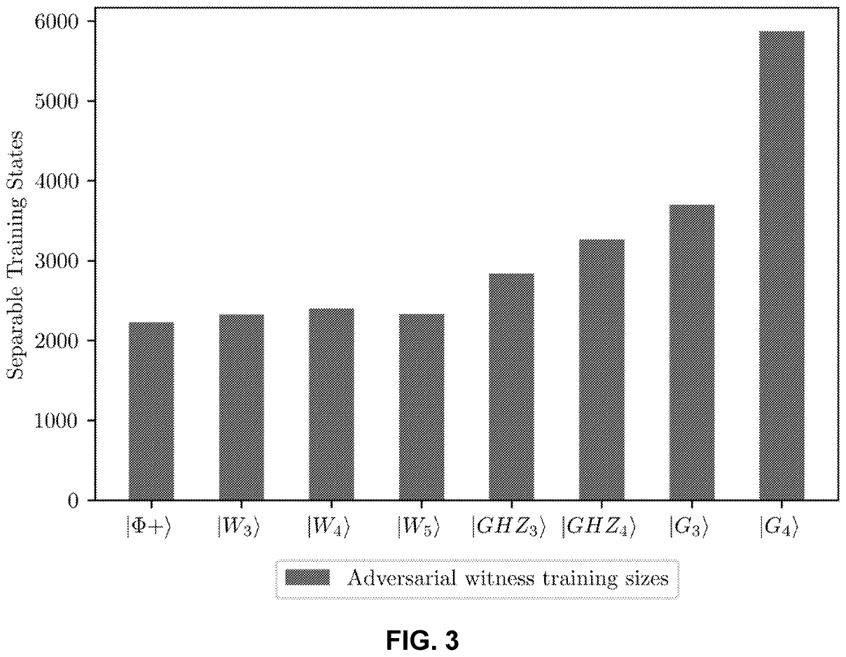

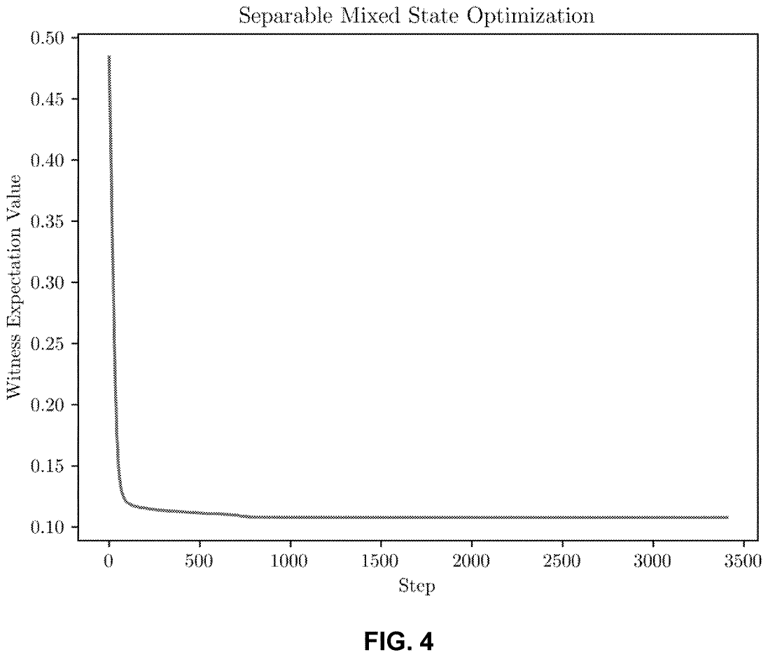

The adversarial approach has a number of significant benefits. For example, as shown with respect to the experimental examples described herein, adversarial training produces entanglement witnesses with much higher noise tolerances than training with the separable eigenstates. Additionally, regardless of the size of the quantum system, the machine learning models can be trained while storing only one new state during each training step, and the necessary number of training steps does not increase dramatically with the size of the quantum system. Instead, the training data size can depend on the particular target state and the selected stopping criterion. The number of training steps generally matches the number of separable training states and is shown in FIG. 3. FIG. 3 illustrates the number of separable training states of adversarial qubit witnesses in the example experiments. FIG. 4 illustrates a loss curve for adversarial training of a 6 qubit W state witness. As evidenced in the chart, the loss reaches an apparent minimum before 2000 iterations, suggesting further training was not necessary.

The example experiments illustrate that adversarial training allows for an exponential reduction in training data sizes, down to O(1). Generally, only the most relevant separable training samples are taken advantage of, and the loss function only considers the state with the highest hinge loss.

Adversarial training usually has longer runtimes than non-adversarial training, up to convergence on good witnesses based on empirically derived stopping criteria, and in terms of time per training step. For example, for three, four and five qubit systems, respectively, the adversarial method may take about 75 ms, 290 ms, and 2.9 s per training step, whereas the non-adversarial method may take about 53 ms, 181 ms, and 1.8 s per training step.

For the adversarial training approach, we can use a loss variance threshold and patience as stopping criteria, like for the non-adversarial training approach. For example, a small threshold, usually 10⁻⁶ and patience of 2000 epochs may be used. These stopping criteria may allow for better witnesses while converging within a reasonable amount of time. When the adversarial training approach is close to convergence, the witnesses change less between iterations than witnesses found with the non-adversarial method because the training states generated by the optimizer are very close together. Due to the stability of the adversarial training approach, the loss changes less between iterations as well and a smaller loss variance threshold is appropriate.

The Example experiments generated examples of a wide variety of entanglement witnesses for entangled states of qubits and qudits, which were found using both adversarial training and non-adversarial training. More specifically, the noise tolerances for entanglement witnesses found with the method 200 given specific numbers of measurements. The example experiments determined a range of analytical results for some of the same states, and provided the best entanglement witnesses found using both adversarial and non-adversarial training.

For the |φ⁺ [symbol] state, the stabilizer approach for finding entanglement witnesses for GHZ-type states was extended down to 2 qubits, for a fair comparison between entanglement witnesses with 2 measurement settings, as opposed to 4 global measurement settings used by an entanglement witness constructed from the CHSH criterion.

The state |G_{N} [symbol] is defined as an N qubit hypergraph state with only a single maximum cardinality hyperedge. A maximum cardinality hyperedge means that each qubit is entangled with every other through an extended controlled NOT (CNOT) gate. Such states can be leveraged to exploit correlations between all qubits in the quantum system and so are useful for quantum computing algorithms. In general, hypergraph states with a maximum cardinality hyperedge use the most measurement settings for both the fidelity and stabilizer approaches. The method 200 was compared to these analytical methods for the case of a state with a single hyperedge. This case was used in the example experiments due to the simplicity preparing the state, being the best illustration of the advantages of the method 200, and for the practical utility of such states in quantum computing.

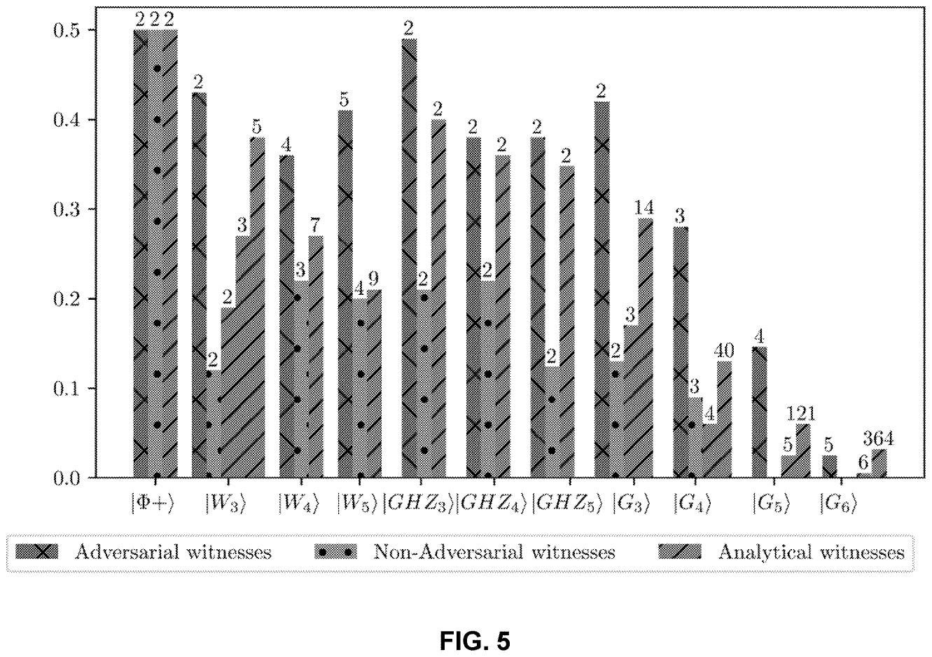

The example experiments were also compared to the limits of Werner state noise defined in the noise equation described herein, past which states are known to be separable. Noise tolerances of analytical qudit entanglement witnesses and the generated qudit entanglement witnesses of the method 200 were compared below in Tables 2 through 4 and in FIG. 5. FIG. 5 is a chart showing noise tolerances of analytic and generated qubit witnesses. The number of measurement settings for each witness is indicated above each bar. Each group of bars are shown above the label indicating the target state.

TABLE 2
Qualities of Analytical Entanglement Witness for Qubit States

| | | | Number of | Noise | |
|---|---|---|---|---|---|
| Target State | d | N | Measurements | Tolerance | Method |
| Φ+ | 2 | 2 | 2 | 0.50 | Stabilizers |
| W | 2 | 3 | 2 | 0.19 | Stabilizers |
| W | 2 | 3 | 3 | 0.27 | Stabilizers |
| W | 2 | 3 | 5 | 0.38 | Fidelity |
| W | 2 | 4 | 7 | 0.27 | Fidelity |
| W | 2 | 5 | 9 | 0.21 | Fidelity |
| W | 2 | 6 | 11 | 0.17 | Fidelity |
| GHZ | 2 | 3 | 2 | 0.40 | Stabilizers |
| GHZ | 2 | 4 | 2 | 0.36 | Stabilizers |
| \|G₃ [symbol] | 2 | 3 | 3 | 0.17 | Stabilizers |
| \|G₃ [symbol] | 2 | 3 | 14 | 0.29 | Stabilizers |
| \|G₄ [symbol] | 2 | 4 | 4 | 0.06 | Stabilizers |
| \|G₄ [symbol] | 2 | 4 | 40 | 0.13 | Stabilizers |

TABLE 3
Qualities of Entanglement Witnesses for Qubit States Generated
with Adversarial Training

| | | | Number of | Noise | Noise Tolerance |
|---|---|---|---|---|---|
| Target State | d | N | Measurements | Tolerance | Limit |
| Φ+ | 2 | 2 | 2 | 0.58 | 0.666 |
| W | 2 | 3 | 2 | 0.43 | 0.521 |
| W | 2 | 4 | 3 | 0.33 | 0.526 |
| W | 2 | 5 | 4 | 0.24 | — |
| GHZ | 2 | 3 | 2 | 0.49 | 0.571 |
| GHZ | 2 | 4 | 2 | 0.38 | 0.533 |
| \|G₃ [symbol] | 2 | 3 | 2 | 0.42 | — |
| \|G₄ [symbol] | 2 | 4 | 2 | 0.28 | — |

TABLE 4
Qualities of Entanglement Witnesses for Qubit States Generated
with Non-Adversarial Training

| | | | Number of | Noise | Noise Tolerance |
|---|---|---|---|---|---|
| Target State | d | N | Measurements | Tolerance | Limit |
| Φ+ | 2 | 2 | 2 | 0.58 | 0.666 |
| W | 2 | 3 | 2 | 0.11 | 0.521 |
| W | 2 | 4 | 3 | 0.22 | 0.526 |
| W | 2 | 5 | 4 | 0.20 | — |
| GHZ | 2 | 3 | 2 | 0.21 | 0.571 |
| GHZ | 2 | 4 | 2 | 0.22 | 0.533 |
| \|G₃ [symbol] | 2 | 3 | 2 | 0.13 | — |
| \|G₄ [symbol] | 2 | 4 | 3 | 0.09 | — |

As illustrated above, the example experiments determined that adversarial training produced the best results by far, producing higher noise tolerances for W state entanglement witnesses with half as many measurements when compared to the fidelity approach. The results of Table 3 illustrate that adversarial training dramatically outperforms hypergraph state stabilizer entanglement witnesses, producing much higher noise tolerances than can be found even with the fidelity approach while using less than the minimum number of measurements used by the stabilizer approach. In particular, the best results were the 4-qubit hypergraph state, where the witness was found with just three measurements and more than double the noise tolerance of the best analytical witness using 40 measurements. The results of Table 4 illustrate that while non-adversarial training generally produced lower noise tolerances, adversarial training offered entanglement witnesses with fewer measurement settings in the hypergraph case and maintained the advantage of shorter runtimes. Both training approaches retain the advantage of universal automation for entanglement witness discovery and grant the freedom to choose the number of global measurement settings in each entanglement witness. For both training approaches, entanglement witnesses were found using default learning rates of 0.01 and trained for less than 6000 epochs.

In the example experiments, to generate separable testing data, pure states were sampled independently for each subsystem as the columns of Haar distributed unitary matrices, and combined to form mixed separable states according to the same permutations used for the differential mixed state optimizer. The coefficients for the convex combination of pure states compose a vector x∈ [symbol] defined by a symmetric Dirichlet distribution defined as:

$$D i r ( x \vert α ) = \frac{Γ ( K α )}{{( Γ ( α ) )}^{K}} {\prod }_{j = 1}^{K} {x}_{j}^{α - 1}$$

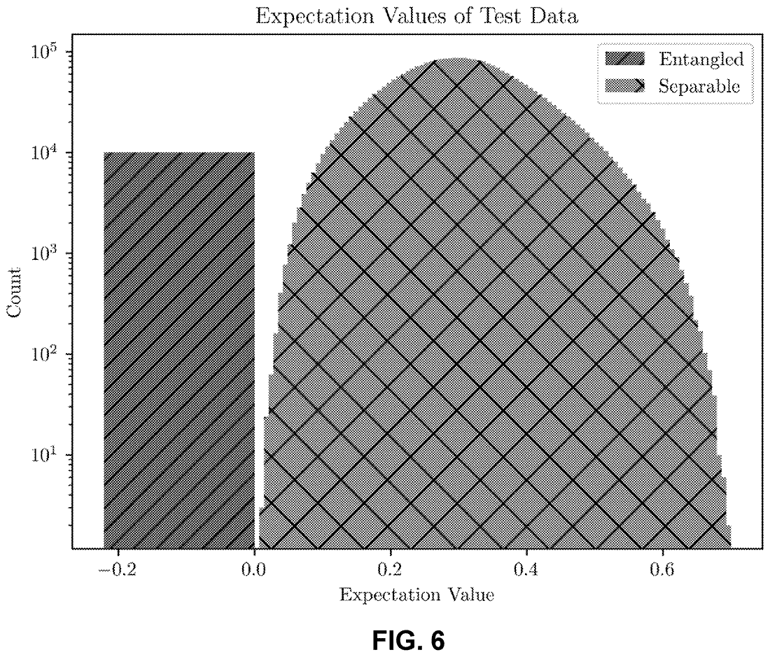

The value K determines how many pure state density matrices appear in the convex combination that determines each mixed state for a given subsystem. K=d^{N} was chosen to ensure the sampled states remain high in purity; which was found in the case of 3 qubits to correspond to states with higher fidelity to the target W state and thus provided the best chance for misclassification by any entanglement witness. Smaller values of a were chosen as they had been shown to lead to states with higher purity on average. Since tune a can be tuned to adjust the purity of test states, purer states closer to a pure target state can be chosen for better chances of misclassification. This bias towards separable test states closer to the target is reflected in the histogram in FIG. 6.

Tables 5 and 6 provide additional results from the example experiments for both training approaches with qudit states; particularly those similar to the |φ⁺ [symbol] or GHZ qubit states. These results demonstrate the versatility of the method 200 and offer new entanglement witnesses for each target state.

TABLE 5
Qualities of Entanglement Witnesses for Qudit States Generated
with Adversarial training

| | | | Number of | Noise |
|---|---|---|---|---|
| Target State | d | N | Measurements | Tolerance |
| \|00 [symbol] + \|11 [symbol] + \|22 [symbol] | 3 | 2 | 2 | 0.30 |
| \|00 [symbol] + \|11 [symbol] + \|22 [symbol] + \|33 [symbol] | 4 | 2 | 2 | 0.38 |
| \|00 [symbol] + \|11 [symbol] + \|22 [symbol] + \|33 [symbol] + \|44 [symbol] | 5 | 2 | 2 | 0.30 |
| \|00 [symbol] + \|11 [symbol] + \|22 [symbol] + \|33 [symbol] + | 6 | 2 | 2 | 0.37 |
| \|44 [symbol] + \|55 [symbol] | | | | |
| ${\sum }_{i = 0}^{9} \vert ii 〉$ | 10 | 2 | 2 | 0.24 |
| \|000 [symbol] + \|111 [symbol] + \|222 [symbol] | 3 | 3 | 2 | 0.18 |

TABLE 6
Qualities of Entanglement Witnesses for Qudit States Generated
with Non-Adversarial training

| | | | Number of | Noise |
|---|---|---|---|---|
| Target State | d | N | Measurements | Tolerance |
| \|00 [symbol] + \|11 [symbol] + \|22 [symbol] | 3 | 2 | 2 | 0.37 |
| \|00 [symbol] + \|11 [symbol] + \|22 [symbol] + \|33 [symbol] | 4 | 2 | 3 | 0.11 |
| \|00 [symbol] + \|11 [symbol] + \|22 [symbol] + \|33 [symbol] + \|44 [symbol] | 5 | 2 | 4 | 0.18 |
| \|000 [symbol] + \|111 [symbol] + \|222 [symbol] | 3 | 3 | 3 | 0.13 |

For each of the entanglement witnesses in the example experiments, their validity was verified by generating at least 100,000 test states. One sample test histogram is presented in FIG. 6, representing the test results of a 3-qubit W state entanglement witness, with 2 measurements, generated with adversarial training. The states counted by the bars to the right of expectation value 0.0 represent separable mixed states, and the bar between the expectation values 0 and −0.2 represents copies of the target W state. As shown, the separable states have only positive expectation values, meeting the definition of an entanglement witness. The target state was tested for visualization purposes as the performed computation of the noise tolerance for each entanglement witness explicitly tested Werner states up to where they had expectation values of 0.

As described herein, the present embodiments provide two approaches for generating entanglement witnesses with machine learning. These two approaches are defined by trainable measurement tensors in which a user may specify exactly how many measurements they wish to use to construct the entanglement witness. These approaches can be advantageously extended to create entanglement witnesses for arbitrary states of qubits or qudits. In one case, the entanglement witnesses are trained using the eigenstates of the lambda operators, while in the other case, the entanglement witnesses are trained using an adversarial scheme in which the entanglement witness training competes with an optimizer searching for misclassified separable states. For both cases, optimization can be performed for separable mixed states, which reaches every possible separable state. The example experiments illustrate the effectiveness of both approaches across a variety of qubit and qudit states, showing that in most cases the method 200 can find entanglement witnesses with fewer measurement settings and/or higher noise tolerances when compared with constructing entanglement witnesses with the stabilizer formalism and fidelity approaches.

As described herein, the present embodiments advantageously allow for the generation of entanglement witnesses where the number of measurement settings may be directly specified by a user. While previous approaches for constructing entanglement witnesses generally express results in terms of a standard basis for local measurements (e.g., like the Pauli basis), the present embodiments can directly train and produce the specified number of Hermitian matrices; which can be represented by the same number of measurement settings on a given quantum system. For N qudits of dimension d, the eigenstates of the generalized Pauli matrices, lambda operators, or Mutually Unbiased Bases (MUBs) can be used for each qudit as training data to determine the correct measurement settings. Additionally, the bias term of the entanglement witness can be adjusted with a differential optimizer to ensure maximal noise tolerance and accuracy. Furthermore, adversarial training can be used to produce entanglement witnesses of higher noise tolerance with fewer measurement settings.

In the example experiments, the performance of the present embodiments was demonstrated by having the method 200 applied to Bell states, GHZ states, W states, hypergraph states, and a range of qudit states. Further, quantum systems from 2 to 6 qubits, bipartite qudits up to d=10, and tripartite qutrits were also considered.

The example experiments also conducted a physical verification of some of the witnesses, by way of verification on photonic qubits and verification on superconducting qubits, to complement the above numerical verification of the witnesses.

In the physical verification experiments, photonic verification included verifying the witnesses generated by the adversarial approach experimentally using photonic quantum states. In the experiments, a rotated |Ψ+ [symbol] state was generated, and the machine learning approach was used to generate a witness to detect this state. The experiments showed that by physically introducing white noise, a witness expectation value crossing 0 was measured at the same value of p, which was determined by setting the expectation value of the witness with a state given by equation 1 equal to zero. Entangled photon pairs were used in the telecommunication band (1530-1600 nm) to realize a target state. To generate the entangled state, the experiments used Spontaneous Parametric Down Conversion (SPDC) with a Periodically Poled Silica Fiber.

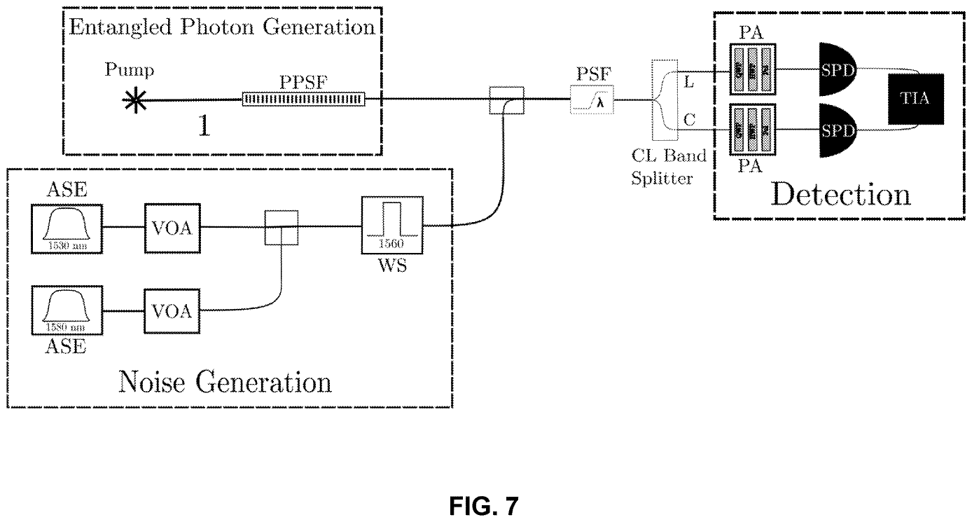

The experimental set up is depicted in FIG. 7. Block 701 shows the experimental set up for creating the noisy bipartite entangled photonic state. Block 702 shows the experimental setup for adding noise to the entangled state. Block 703 shows the experimental setup for local projective measurements on each photon. A 780 nm pump was used, supplying a Periodically Poled Silica Fiber (PPSF) to generate entangled photons. The signal was combined with the noise using a 50/50 splitter, and the total signal was put through a Pump Suppression Filter (PSF) before separating the C and L band components for measurement. A Polarization Analyzers (PAs) consisting of a quarter waveplate was used, and a half waveplate was used to project the photons onto the polarizer before the single photon detectors.

The experiments introduced C-band (1530-1565 nm) and L-band (1570-1600 nm) noise through an Amplified Spontaneous Emission (ASE) source in each band, which were combined through an optical coupler. ASE noise was added due to its broad, flat spectrum, which equally influences both frequency bands and so both qubits. Balanced noise was ensured across both bands with a Finisar 4000A Wavershaper. The SPDC signal was combined with the ASE noise. A C-L band splitter was used to separate the entangled photon pair and put each band through a polarization analyzer, each consisting of a Quarter Wave Plate, Half Wave Plate, and Polarizer. The polarization analyzer enabled projective measurements in arbitrary bases, so the expectation value of any operator could be measured. The resulting photon counts were measured through single photon detectors.

Since each local measurement setting for the witness can be represented by Hermitian operators, and they can be diagonalized and decomposed into projective measurements corresponding to particular eigenstates. A gradient descent was used to find waveplate settings which would rotate each eigenstate onto the |H [symbol] state. Using a time interval analyzer, detection times of infrared photons in the C and L wavelength bands were compared and it was found that detections coincide with higher likelihood after a particular delay. Since the entangled photons are generated at the same instant in the SPDC process, it can be reasonably expected to see the most coincidences after a fixed delay related to the optical path lengths in the present setup. The peak of these coincidences was determined for each measurement and compared the number of counts to determine the relative probabilities of our photonic state being observed in each eigenstate. To compute the witness expectation value, the eigenvalues corresponding to each local and global eigenstate were used along with the coefficients of the witness for each one or two qubit measurement comprising. The local eigenstates can be found by diagonalizing each local measurement setting, and the global eigenstates are given by the tensor products of the local eigenstates. Precisely, we can diagonalize measurement Hᵢⱼ, meaning measurement i on qubit j, as

$${H}_{ij} = {U}_{ij} {D}_{ij} {U}_{ij}^{†}$$

for some unitary matrix Uᵢⱼ whose columns comprise a basis of the eigenstates of Hᵢⱼ, and a diagonal matrix Dᵢⱼ, where each element is an eigenvalue of Hᵢⱼ. For measurement i we can then compute each global eigenstate as one column of the matrix:

$${U}_{i} = {⊗}_{j} {U}_{ij}$$

The probabilities of measuring each single qubit eigenstate from the probabilities of measuring each two qubit eigenstate can be inferred. The expectation value of measurement Hₐ with probabilities {p_{ab}} corresponding to outcomes of measurement a on qubit b was determined. The generated state collapsed into one of the eigenstates in the set {|Φ_{ab} [symbol] } for measurement Hₐ. Using the corresponding eigenvalues {Λ_{ab}}, the experiments determined the expectation value of measurement Hₐ:

$$〈 {H}_{a} 〉 = {\sum }_{a b} {p}_{a b} {Λ}_{a b}$$

To compute the non-normalized expectation value of the witness [symbol] W [symbol] , the experiments determined the weighted sum:

$$〈 W 〉 = {c}_{0} + {\sum }_{a} {c}_{a} 〈 {H}_{a} 〉$$

Each of polarization analyzer consisted of a quarter wave plate, half wave plate, and a polarizer. To measure the witness, the example experiments diagonalized each local operator to decompose it into projective measurements, and used gradient descent to find the waveplate settings needed to project those eigenstates onto the Z basis.

For each measurement of the witness, the example experiments used an 80 second integration time for each measurement. The coincidence histograms had a temporal resolution of picoseconds. To determine the coincidence peak, all bins in the histograms with counts more than one standard deviation of the counts in all bins were grouped. The other bins were considered as noise.

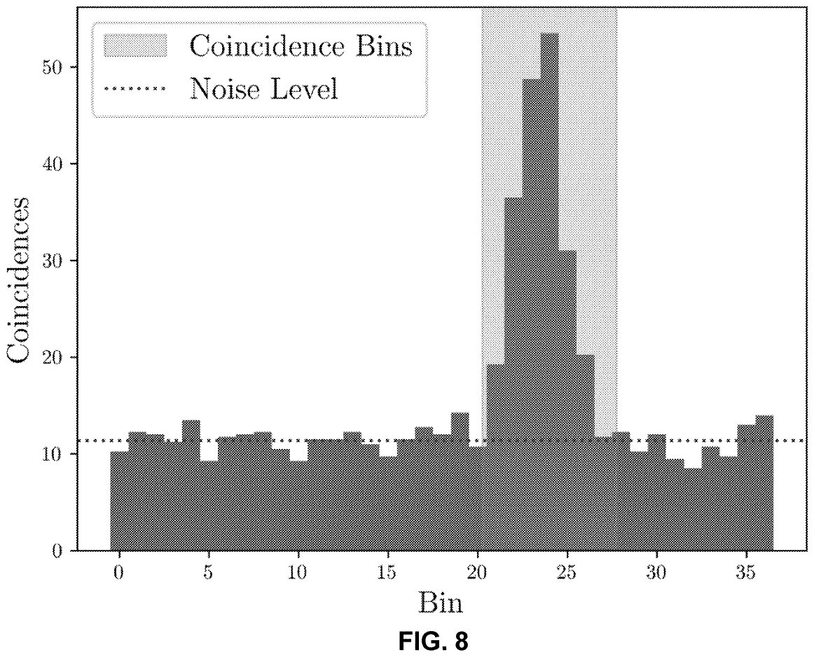

To compute the p value from coincidence counts for a noisy signal, the sum of all histograms of coincidences was determined. A plot of the cumulative coincidences across all measurements is shown in FIG. 8. FIG. 8 shows a histogram of coincidence events added together for all witness measurements; showing standard deviation of all bins, which were used to find the noise level by averaging those not in the coincidence peak.

Since the measurements are Hermitian operators, they can be diagonalized into projective measurements which form a basis, according to the spectral theorem. The p value is the ratio of noise to signal in the absence of optical elements, or the ratio of uncorrelated photons to correlated photons in an arrival time measurement where no optical elements are placed after the PPSF. This is equivalent to measuring the expectation value of a projective measurement of every element in a basis onto the target state, as Tr(ρ)≡Σᵢ [symbol] Φᵢ|ρ|Φᵢ [symbol] =1.

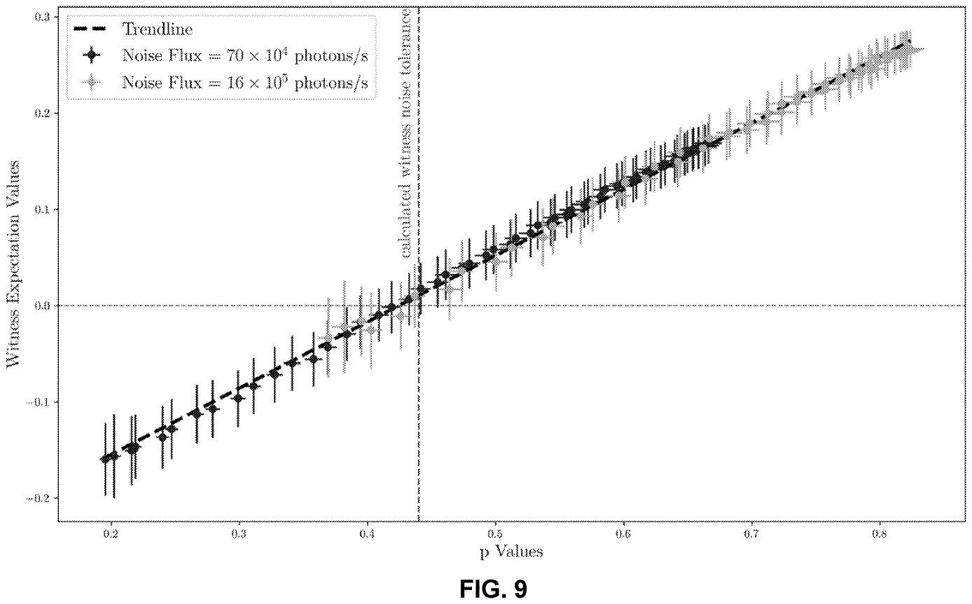

The example experiments measured the coincidences for two levels of noise, and raised the noise seen by the witness by averaging the signal with more noise bins, one bin at a time. The p value was determined as the ratio between the average signal and average noise in each case. In FIG. 9, is a chart illustrating expectation value of the witness compared to p value. FIG. 9 shows a p value where the witness produces a positive expectation value in the range between 0.4 and 0.5, consistent with the calculated noise tolerance of 0.44. The noise fluxes quoted in the legend refer to the total counts received by both detectors without the presence of the entangled signal photons.

With the photonic experiment, the example experiments confirmed that the measured expectation value the machine learning derived witness crosses zero close to the calculated noise tolerance. The witness for this physical mixed state behaves as expected with this physical experiment.

In the example experiments, for the verification on superconducting qubits, experiments were conducted on a superconducting device (referred to as ‘ibm_quebec’) where the experiments made a determination of the efficacy of the hypergraph witness when faced with intrinsic decoherence and dephasing of the system. The experiments compared the witness against the existing fidelity method, in terms of both the number of measurement settings required and the relative noise tolerance. The experiments determined two important results: (1) the present hypergraph witnesses have superior noise tolerance to the fidelity method while requiring fewer measurement settings, and (2) the present witness' prediction is in accordance with genuine multipartite entanglement measures.

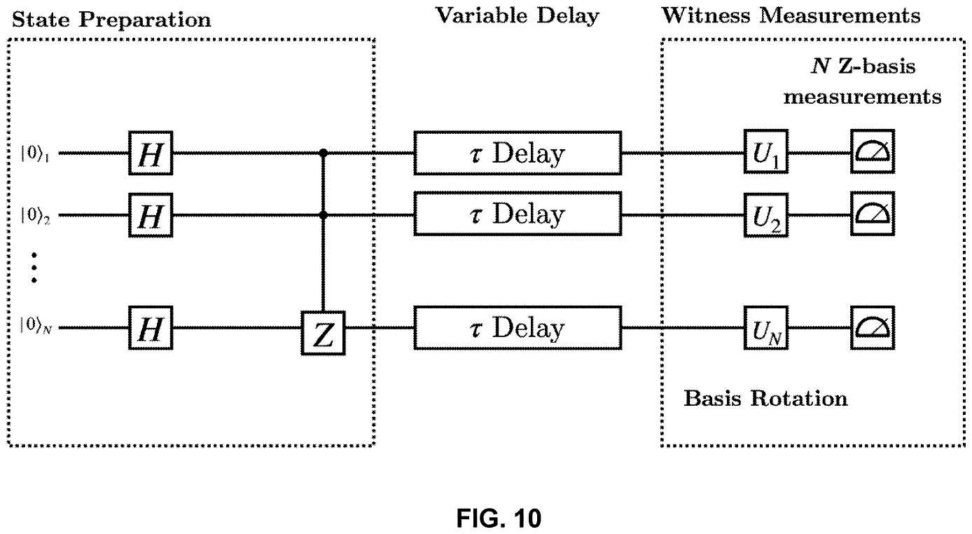

FIG. 10 illustrates a diagram of the quantum circuit used to generate hypergraph states and measure the hypergraph state witness in the example experiments. It includes Hadamard gates on each qubit and a multi-control Z gate. Delay is added to each qubit to induce noise. Each qubit is projected onto each eigenstate of each measurement to measure the witness. In this way, FIG. 10 shows a depiction of the quantum circuit used to compare of both candidate witnesses. MN identical copies of maximum-cardinality were prepared, with 3-qubit hyper graph states G3; where M is the number of measurement settings required for a given witness and N is the number of copies required for estimating an expectation value. The circuit used for preparing G3 is marked as the “state preparation” stage in FIG. 10. After state preparation, the system can idle for a fixed duration, ranging between 0 and 16 μs, which is used to introduce a controlled amount of noise to the prepared state. The dominant noise mechanisms during these idle periods are mainly due to relaxation and dephasing. Consequently, the noise injected into the system is stochastic and incoherent in nature, with exception to coherent errors introduced by cross-talk between qubits. After each delay, measurements are performed for both witnesses and their expectation values are determined; the measurement circuits themselves are implemented in the form of local unitary rotations followed by Z-basis measurements.

Following the comparison between fidelity and the approach of the present embodiments, the genuine multipartite entanglement present in the prepared state after each value of delay was determined. To do so, the experiments performed a 3-qubit, quantum state tomography to produce an estimated density matrix ρₑₛₜ. The multipartite entanglement possessed by ρₑₛₜ is determined by evaluating a semi-definite program.

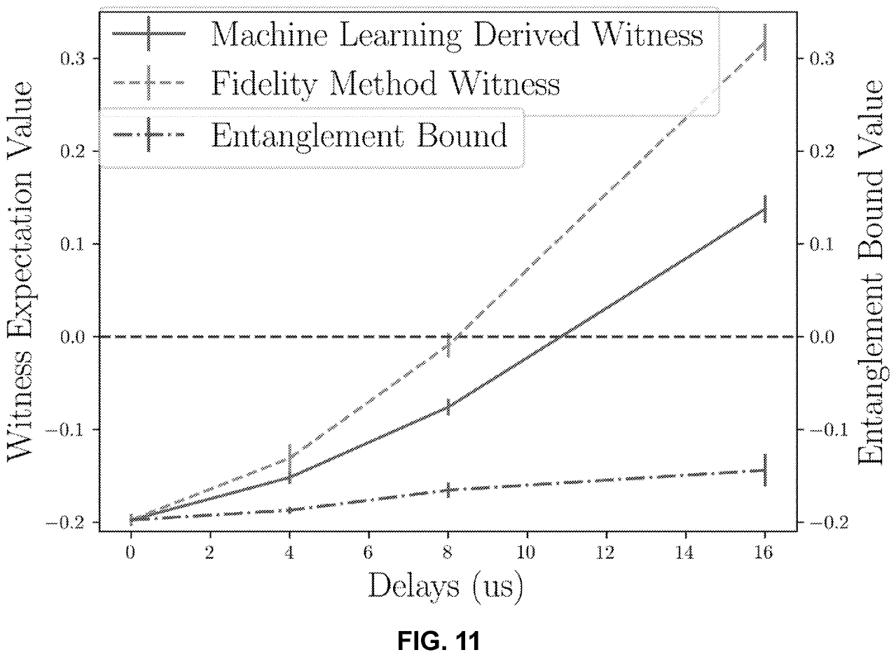

FIG. 11 is a graph showing expectation values of the fidelity witness and the witness of the present embodiments with increasing amounts of noise on quantum computing hardware. The entanglement bound is a measure of entanglement derived from full quantum state tomography to ensure both witnesses are correctly classifying the noisy states. FIG. 11 shows how both fidelity and the machine-learning derived approach of the present embodiments predict deterioration of entanglement over a span of 16 μs. The experiments determined that the machine-learning-derived witness offers noise tolerance superior to the fidelity approach, while remaining in accordance with the expected resource-intensive entanglement of the estimated state ρₑₛₜ. The “noise tolerance” of a witness in this experiment is defined as the amount of idle delay required for the expectation value to become positive. It was found that while the fidelity-method can only sustain 8 μs of sustained delay, the witness of the present embodiments can withstand ~11 μs while requiring a fraction of the measurement settings (2 vs. 14). The difference in 3 μs is very significant, since most superconducting gate-operations take place on the order of 10 s of ns.

Accordingly, the physical verification experiments performed on several witnesses demonstrate that the p value determined for the witness in the present embodiments, from photonic and superconducting qubit states, matches the p value which can be found through experiment.

The computational complexity and data processing requirements of the described embodiments significantly exceed what could be performed effectively through human mental processes, underscoring the technical nature and necessity of computer implementation. The invention provides a solution to entanglement witness for detecting entanglement in a quantum system, comprising computation techniques that process vast amounts of extremely complex data with high efficiency and accuracy. In some cases, the described embodiments leverage advanced and sophisticated mathematical models and techniques that surpass human cognitive capabilities in speed, accuracy, and scalability, in order to achieve the technical advancements. In some cases, embodiments of the present disclosure can be implemented on specialized hardware and software platforms designed to handle the extensive computational load, thereby offering significant improvements over conventional human-performed tasks. In this way, the interaction between these components/steps and the technical outcomes achieved by the present embodiments, such as arriving at a realistic entanglement witness, are impractical for human cognition to replicate due to the scale and complexity of the operations involved.

Although the foregoing has been described with reference to certain specific embodiments, various modifications thereto will be apparent to those skilled in the art without departing from the spirit and scope of the invention as outlined in the appended claims. The scope of the claims should not be limited by the preferred or example embodiments, but should be given the broadest reasonable interpretation consistent with the specification as a whole.

1. A computer-implemented method for generating an entanglement witness for detecting entanglement in a quantum system, the method comprising:
receiving a target entangled state;
generating an entanglement witness for the target entangled state by training a machine learning model to generate the entanglement witness based on at least two measurement settings until a stopping criterion is reached;
optimizing the entanglement witness based on a determination of a most misclassified separable state; and
outputting the entanglement witness.

2. The method of claim 1, wherein the machine learning model comprises an adversarial trained model, training of the adversarial trained model comprises repeatedly, until the stopping criterion is reached, alternating between:
training of the machine learning model to generate a trial witness for the entanglement witness; and
generating training data to attempt to invalidate the trial witness.

3. The method of claim 1, wherein the machine learning model is trained using training data determined by eigenstates of generalized Pauli matrices, generalized lambda operators, or a set of Mutually Unbiased Basis (MUB) states of the quantum system.

4. The method of claim 1, wherein training the machine learning model comprises training a Hermitian matrix for each qubit or qudit in the quantum system and each of the measurement settings, the Hermitian matrices represent quantum observables.

5. The method of claim 4, wherein training the machine learning model comprises a linear combination of the Hermitian matrices according to a one-dimensional array of trainable coefficients.

6. The method of claim 4, wherein each Hermitian matrix is determined by taking products of the measurement tensors for local measurements across all qubits or qudits for each of the measurement settings.

7. The method of claim 5, wherein the one-dimensional array of coefficients includes a bias term that corresponds to an identity operator on the quantum system.

8. The method of claim 1, wherein the machine learning model comprises a support vector machine, and wherein training of the support vector machine comprises:
determining Hermitian measurement matrices from the generated training data;
determining the entanglement witness from the Hermitian measurement matrices and trainable coefficients;
determining an expectation value of training states with the entanglement witness;
determining a loss as a maximum hinge loss across all training states; and
updating the entanglement witness according to gradients with respect to the loss using differentiation.

9. The method of claim 2, wherein, at the end of all repetitions, the entanglement witness is optimized to ensure all separable states have a positive expectation value.

10. The method of claim 1, wherein optimizing the entanglement witness comprises:
determining pairs of trainable matrices with nonnegative real diagonal elements;
determining swaps of qubits or qudits for bipartitions of the quantum system; and
for each step in a plurality of steps:
determining a separable state from the pairs of the trainable matrices across all of the permutations of all of the bipartitions;
determining an expectation value of said separable state;
performing automatic differentiation to update variables in each of the trainable matrices so as to optimize said separable state by gradient descent; and
finding the separable state with the lowest expectation value for the given witness.

11. A system for generating an entanglement witness for detecting entanglement in a quantum system, the system comprising one or more processing units and a non-transitory memory for data storage, the non-transitory memory in communication with the one or more processing units for execution of:
an input module to receive a target entangled state;
a machine learning module to generate an entanglement witness for the target entangled state by training a machine learning model to generate the entanglement witness based on at least two measurement settings until a stopping criterion is reached;
an optimization module to optimize the entanglement witness based on a determination of a most misclassified separable state; and
and an output module to output the entanglement witness.

12. The system of claim 11, wherein the machine learning model comprises an adversarial trained model, training of the adversarial trained model comprises repeatedly, until the stopping criterion is reached, alternating between:
training of the machine learning model to generate a trial witness for the entanglement witness; and
generating training data to attempt to invalidate the trial witness,
wherein, at the end of all repetitions, the entanglement witness is corrected based on the trial witness to ensure all separable states have a positive expectation value.

13. The system of claim 11, wherein the machine learning model is trained using training data determined by eigenstates of generalized Pauli matrices, generalized lambda operators, or a set of Mutually Unbiased Basis (MUB) states of the quantum system.

14. The system of claim 11, wherein training the machine learning model comprises training a Hermitian matrix for each qubit or qudit in the quantum system and each of the measurement settings, the Hermitian matrices represent quantum observables.

15. The system of claim 13, wherein training the machine learning model comprises a linear combination of the Hermitian matrices according to a one-dimensional array of trainable coefficients.

16. The system of claim 13, wherein each Hermitian matrix is determined by taking products of the measurement tensors for local measurements across all qubits or qudits for each of the measurement settings.

17. The system of claim 14, wherein the one-dimensional array of coefficients includes a bias term that corresponds to an identity operator on the quantum system.

18. The system of claim 11, wherein the machine learning model comprises a support vector machine, and wherein training of the support vector machine comprises:
determining Hermitian measurement matrices from the generated training data;
determining the entanglement witness from the Hermitian measurement matrices and trainable coefficients;
determining an expectation value of training states with the entanglement witness;
determining a loss as a maximum hinge loss across all training states; and
updating the entanglement witness according to gradients with respect to the loss using differentiation.

19. The system of claim 11, wherein, at the end of all repetitions, the entanglement witness is optimized to ensure all separable states have a positive expectation value.

20. The system of claim 11, wherein optimizing the entanglement witness by the optimization module comprises:
determining pairs of trainable matrices with nonnegative real diagonal elements;
determining swaps of qubits or qudits for bipartitions of the quantum system; and
for each step in a plurality of steps:
determine a separable state from the pairs of the trainable matrices across all permutations of the bipartitions;
determining an expectation value of said separable state; and
performing automatic differentiation to update variables in each of the trainable matrices so as to optimize said separable state by gradient descent; and
finding the separable state with the lowest expectation value for the given witness.
